(19) United States
(12) Patent Application Publication
(10) Pub. No.: US 2018/0136164 A1
(43) Pub. Date: May 17, 2018

(54) SYSTEMS AND METHODS TO EXTRACT TARGET MATERIAL FROM A GEL

(71) Applicant: SeqMatic, LLC, Fremont, CA (US)

(72) Inventors: Danny LEE, Fremont, CA (US); Shang Moon YAEP, Fremont, CA (US)

(21) Appl. No.: 15/809,865

(22) Filed: Nov. 10, 2017

Related U.S. Application Data
(60) Provisional application No. 62/421,938, filed on Nov. 14, 2016.

(51) Int. Cl. G01N 27/447; B01L 3/00; B04B 5/10

(52) U.S. Cl. CPC G01N 27/44739; G01N 27/44756; B01L 3/502; B01L 2300/08; B01L 2300/0672; B01L 2300/0681; B04B 5/10

(57) ABSTRACT

A device, system, and method of extracting a target component from a gel. A gel processing system comprises a gel excision and fragmentation device with a cutting edge shaped to cut a sample containing a targeted component from a gel, a receptacle shaped to receive the gel sample, and a fragmentation membrane to fragment the gel sample coupled to a receiving container. The gel processing system may be used in conjunction with a centrifuge to break down gel material surrounding the targeted component cause the fragmentation as well as to facilitate additional processing.

### CROSS-REFERENCE

This application claims the benefit of U.S. Provisional Application No. 62/421,938, filed Nov. 14, 2016, which application is incorporated herein by reference.

### BACKGROUND

Gel electrophoresis—a method for separating and analyzing molecules, such as deoxyribonucleic acid (DNA), ribonucleic acid (RNA), and proteins, from a mixture—is used extensively in the fields of biology and biotechnology. Having deposited a mixture into a gel, typically a crosslinked polymer, the gel is subjected to an electric field that drives the molecules of the mixture down its length, separating them by their size and charge. As the components of the mixture separate down the length of the gel, distinct bands of individual components form, from which a specific component can be targeted for removal or extraction from the gel for further analysis. Currently, the most prevalent technique used to this end is to excise the band containing the target component by cutting it from the surrounding gel with a razor blade or scalpel, drawing out the band with a pair of tweezers, and then transferring the band of material to a receiving container, such as an Eppendorf tube.

There are several downsides to such an approach, including the inherent potential danger of sharp-edged instruments to their users, poor reproducibility of band excision which can lead to significant variability in additional assays, and the cumbersomeness of having to use separate tools to cut, draw out, and transfer a band of the target component to a container. Moreover, once the band has been transferred to a container, it must often be further pulverized to aid in subsequent analysis.

### SUMMARY

In light of difficulties with manual blade-based excision, recognized herein is the need for a user-friendly device, system, and method for excising or cutting, drawing out, and transferring a band of gel material containing a target component to a desired location.

Briefly and in general terms, the present disclosure provides devices, systems, and methods for excising a target band from a gel. A target component may then be isolated or extracted from the excised band. The target component may comprise a specific nucleotide, collection of nucleotides, protein, collection of proteins, molecule, or collection of molecules, or any combination thereof. The gel may comprise an electrophoresis gel comprising agarose, polyacrylamide, starch, or any comparable crosslinked polymer, or any combination thereof. The present disclosure focuses on embodiments providing for the excision of target bands from an electrophoresis gel in preparation for further fragmentation, extraction, processing, and/or chemical analysis. One of skill in the art will appreciate that this use is not intended to be limiting and that other target components and types of gel may also be used.

In a first aspect of the present disclosure, a device for excising and fragmenting a target band from a gel may comprise a receptacle shaped to receive a band from a gel, the receptacle having a cutting edge shaped to cut the band from the gel when pressed thereon, thereby urging the cut band into the receptacle, a fragmentation membrane having a first end coupled to an end of the receptacle opposite the cutting edge and a second end, and a coupler coupled to the second end of the fragmentation membrane. The receptacle may have a length between a proximal end of the receptacle and a distal end of the receptacle sufficient to hold at least some portion of an extracted gel band within the receptacle. The receptacle may be shaped to hold a single band of DNA, RNA, protein, or molecular fragments, or any combination thereof, said band possibly being part of a collection of similar bands created during electrophoresis. Disposed at the distal end of the receptacle may be a cutting edge that may be pressed against a gel to separate a desired band from the rest. The profile of the cutting edge of the receptacle may take on a wide variety of cutting edge geometries, such as a round or waterfall hone, a wide variety of free and rake angles, such as the pairing of a free and rake angle each of 0° so that the cutting edge may be substantially parallel to the gel surface when used to cut the gel and essentially dull to touch, and a wide variety of chamfer and/or fillet forms and sizes to assist in the structural or functional integrity of the device. The fragmentation membrane may aid in breaking down a band of the gel into smaller pieces or fragments. The fragmentation membrane may contain holes to aid in breaking down a band of gel into smaller pieces by acting as a sieve through which the gel passes. The coupler may have an inner surface and an outer surface, and the inner surface or the outer surface, or any combination thereof, may provide a region with which to couple the device to a receiving container. The gel excision and fragmentation device comprising a receptacle, a fragmentation membrane, and a coupler may comprise a single, integral unit. This single, integral unit may comprise a biologically inert, non-catalyzing, or non-reactive material.

In another aspect of the present disclosure, a system for processing a band excised or cut from a gel may comprise: a gel excision and fragmentation device comprising a receptacle shaped to cut and/or receive a band from a gel, the receptacle having a cutting edge shaped to cut the band from the gel when pressed thereon, thereby urging the cut band into the receptacle, a fragmentation membrane having a first end coupled to an end of the receptacle opposite the cutting edge and a second end, and a coupler coupled to the second end of the fragmentation membrane; and a receiving container. The receiving container may comprise a centrifuge tube with an open boundary at its distal end and a closed boundary at its proximal end. The receiving container may comprise an Eppendorf tube or any comparable container capable of being centrifuged. The coupler of the gel fragmentation device may be coupled to the receiving container via an interference fit between the coupler of the gel fragmentation device and the receiving container. The coupling between the gel excision and fragmentation device and the receiving container may be aided by a locking mechanism disposed on the coupler of the gel fragmentation device. The system may at times be manipulated by a user to cut a target band from a gel. The system may at times be disposed within a centrifuge.

In still another aspect of the present disclosure, a method for processing a band of a gel may comprise pressing a cutting edge of a receptacle of a gel excision and fragmentation device against a gel to cut a gel band from the gel, thereby urging the cut gel band into the receptacle, coupling a coupler of the gel excision and fragmentation device with an opening of a receiving container, and centrifuging the coupled gel excision and fragmentation device and receiving container. Centrifuging the coupled pair of the gel excision and fragmentation device and receiving container may force the band of gel through a fragmentation membrane of the gel excision or fragmentation device, fragmenting or breaking the band into smaller pieces, and those smaller pieces may be collected in the receiving container. The smaller pieces may then be further cleaned, purified, filtered, or transferred, or any combination thereof. The target component within the smaller pieces may be amplified, tagged for fluorescent imaging, sequenced, or subjected to one or more assays, or any combination thereof.

An aspect of the present disclosure provides a gel excision or fragmentation device comprising: a receptacle shaped to receive the band from the gel, having a cutting edge shaped to cut a band from a gel when pressed thereon (thereby urging the cut band into the sample receptacle); a fragmentation membrane having a first end operatively coupled to an end of the receptacle opposite the cutting edge and a second end; and a coupler operatively coupled to the second end of the fragmentation membrane.

The receptacle of some embodiments may have a length between a proximal end of the receptacle and a distal end of the receptacle sufficient to hold at least a portion of an excised gel band within the receptacle. Furthermore, in some embodiments, the receptacle is shaped to hold a single band of target components (such as deoxyribonucleic acid (DNA), ribonucleic acid (RNA), protein, or molecular fragments, or any combination thereof), the single, target band selected from a plurality of bands generated during electrophoresis.

In some embodiments, the cutting edge of the receptacle comprises a free and rake angle both about 0° such that the cutting edge is dull to touch.

Some embodiments comprise a fragmentation membrane configured to break down the received band of gel into smaller pieces. To do so, some embodiments utilize a fragmentation membrane comprising one or more holes to aid in breaking down the received band of gel by acting as a sieve through which the gel passes.

The coupler of some embodiments comprises an inner surface and an outer surface, with the inner surface or the outer surface, or any combination thereof, providing a region configured to couple to a receiving container.

The receptacle, the fragmentation membrane, and the coupler may comprise a single, integral unit; for instance, may comprise a single, integral unit made of a biologically inert, non-catalyzing, or non-reactive material.

Another aspect of the present disclosure provides a system for processing a band of a gel comprising a gel excision or fragmentation device and a receiving container. The gel excision fragmentation device may be configured to be coupled to the receiving container, such as by an interference fit between a coupler of the gel excision or fragmentation device and the receiving container or via a locking mechanism disposed on the coupler of the gel excision or fragmentation device. The system may be manipulated by a user to cut a target bad from a gel. In some embodiments, the system is configured to be disposed within a centrifuge.

The gel excision or fragmentation device may comprise (a) a receptacle shaped to receive a band from a gel, the receptacle having a cutting edge shaped to cut the band from the gel when pressed thereon, thereby urging the cut band into the receptacle, (b) a fragmentation membrane having a first end operatively coupled to an end of the receptacle opposite the cutting edge and a second end, and (c) the coupler operatively coupled to the second end of the fragmentation membrane.

The receiving container of some embodiments comprises a centrifuge tube with an open boundary at a distal end thereof and a closed boundary at a proximal end thereof. In some embodiments, the receiving container comprises an Eppendorf tube.

Another aspect of the present disclosure provides a method for processing a band of a gel. In some embodiments, the method comprises pressing a cutting edge of a receptacle of a gel excision and fragmentation device against a gel to cut a gel band from the gel, thereby urging the cut gel band into the receptacle and capturing the cut gel band. The method may further comprise coupling a coupler of the gel excision and fragmentation device with an opening of a receiving container. The method may also comprise centrifuging the coupled gel excision or fragmentation device and receiving container containing the captured gel band. In some embodiments, centrifuging the coupled gel excision or fragmentation device comprises forcing the captured gel band through a fragmentation membrane of the gel excision or fragmentation device, thereby breaking or fragmenting the captured gel band into gel fragments, and collecting the gel fragments in the receiving container.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates a perspective view of an exemplary embodiment of a gel excision and fragmentation device emphasizing the coupler.

FIG. 2 illustrates a perspective view of the device of FIG. 1, emphasizing the fragmentation membrane.

FIG. 3 illustrates a front view of the device of FIG. 1.

FIG. 4 illustrates a back view the device of FIG. 1.

FIG. 5 illustrates a perspective view of the device of FIG. 1, emphasizing a locking mechanism.

FIGS. 6A-6F illustrate exemplary embodiments of the cutting edge.

FIGS. 7A-7C illustrate exemplary embodiments of the receptacle walls.

FIGS. 8A-8C illustrate an exemplary method of gel excision using devices according to embodiments.

FIG. 9 illustrates an exemplary system and method for fragmenting an excised gel band by subjecting the excised gel band to an acceleration.

FIG. 10 illustrates an exemplary combination of a gel fragmentation system of FIG. 7 and a centrifuge.

FIG. 11 illustrates a flowchart of a method for gel fragmentation and processing with a centrifuge.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The present disclosure provides devices, systems, and methods of or relating to electrophoresis, gel fragmentation, and post-electrophoresis analysis. Various aspects of the invention described herein may be applied to any of the particular applications set forth below or for any other types of separation systems. The invention may be applied as a standalone device, system, or method, or as part of an integrated sample processing system. It shall be understood that different aspects of the invention can be appreciated individually, collectively, or in combination with each other.

The terms “electrophoresis” and “gel electrophoresis,” as used herein, generally refer to the motion of dispersed particles relative to a material under the influence of an electric field, the process of separating material using an electric field, and/or a method of separating or analyzing macromolecules (nucleic acids, proteins, etc.) and their fragments. Electrophoresis is commonly used to separate charged molecules (such as deoxyribonucleic acid (DNA), ribonucleic acid (RNA), and proteins) by placing a sample containing the charged molecules into a gel matrix, applying an electric field across the gel so that at least one end of the gel has a positive charge and at least one end has a negative charge, said electric field causing the charged molecules within the gel matrix to move through the matrix, wherein smaller molecules tend to travel farther than larger molecules through the gel thereby separating species within the sample based on their size. Put simply, electrophoresis involves the migration of species in a sample through a matrix or medium, such as a gel, in the presence of an electric field. The terms matrix and gel may be used interchangeably throughout this specification. The physical properties of the matrix (such as the size and shape of the pores, the material used, etc.), of the sample (such as the size and shape of the macromolecules contained therein), and of the system (such as the voltage used, the ionic strength of a buffer, the type and concentration of intercalating dye) may affect rates of migration, allowing separation of different species within a sample. Relevant physical properties of sample species include size, electrical charge, and conformation. Electrophoresis may be conducted within any system or apparatus that can provide a matrix (e.g., a gel), a buffer solution, and an electric field.

The term “gel,” as used herein, generally refers to a gel used in electrophoresis. In many embodiments the gel may comprise agarose, polyacrylamide, or starch, or any combination thereof. Descriptions herein will focus on the gel as either an agarose- or polyacrylamide-based matrix, though one of skill in the art will appreciate that other materials may be used. Generally speaking, polyacrylamide gels may be used to separate nucleic acids, including small fragments of nucleic acids (e.g., about 5-500 bp). Agarose gels may be used to separate proteins, including proteins above about 200 kDa. Agarose gels may also be used to separate nucleic acids, including nucleic acids from size about 50 bp up to and including nucleic acids several Mb in size.

The term “sample,” “target,” or “target material” as used herein, generally refers to any biological or organic material. More specifically, samples, targets, or target materials may comprise individual species of macromolecules, micromolecules, amino acids, proteins (e.g., enzymes, antibodies, structural proteins, storage proteins, transport proteins, motor proteins, hormonal proteins, receptor proteins), protein fragments, peptides, and particles), nucleic acids, and direct PCR products. As used herein, the term “nucleic acid” generally refers to a polymeric form of nucleotides of any length, either deoxyribonucleotides (dNTPs) or ribonucleotides (rNTPs), or analogs thereof. Nucleic acids may have any three dimensional structure, and may perform any function, known or unknown. Non-limiting examples of nucleic acids include DNA, RNA, coding or non-coding regions of a gene or gene fragment, loci (locus) defined from linkage analysis, exons, introns, messenger RNA (mRNA), transfer RNA, ribosomal RNA, short interfering RNA (siRNA), short-hairpin RNA (shRNA), micro-RNA (miRNA), ribozymes, cDNA, recombinant nucleic acids, branched nucleic acids, plasmids, vectors, isolated DNA of any sequence, isolated RNA of any sequence, nucleic acid probes, and primers. A nucleic acid may comprise one or more modified nucleotides, such as methylated nucleotides and nucleotide analogs. If present, modifications to the nucleotide structure may be made before or after assembly of the nucleic acid. The sequence of nucleotides of a nucleic acid may be interrupted by non-nucleotide components. A nucleic acid may be further modified after polymerization, such as by conjugation or binding with a reporter agent.

As used herein, the term “subject,” generally refers to an entity or a medium that has extractable, testable, or detectable material from which a sample has, can be, or will be taken. A subject can be a person or individual. A subject can be a vertebrate, such as, for example, a mammal. Non-limiting examples of mammals include murines, simians, humans, farm animals, sport animals, and pets. Other examples of subjects include food, plant, soil, and water.

The term “diameter” as used herein generally refers to a unique measure of a shape. “Diameter” does not refer exclusively to circles or spheres, though at times it does refer to circles and/or spheres. Generally speaking, a diameter is a straight line passing from one side to another through the center of a shape. It may include a dimension representing the smallest distance between one or more sides or tangents to sides within a shape, a dimension representing the largest distance between one or more sides or tangents to sides within a shape, and may include one or more diameters.

As used herein, the terms gel “excision” or “cutting” will be used throughout to refer to the excision, cutting, or other type of removal of a target band or bands from a gel.

As used herein, the term gel “breaking” and “fragmentation” will be used throughout to refer to the processes of “breaking,” “fragmenting,” or otherwise dividing a gel band, such as an excised gel band, into smaller components, such as for downstream chemical or physical processing.

As used herein, the term gel “extraction” and “extracting” will be used throughout to encompass and refer to the gel-based processes of capturing, separating, or isolating a sample, a target, a target material, or a target molecule or molecules from a gel and/or gel band, including any physical, mechanical, and/or physical sub-processes or sub-steps.

As used in the specification and claims, the singular form “a”, “an” and “the” include plural references unless the context clearly dictates otherwise. For example, the term “a cell” includes a plurality of cells, including mixtures thereof.

The present disclosure provides devices, methods and systems to isolate a target component from a mixture. That mixture may comprise any of the target materials described within the body of this specification (for example, macromolecules, proteins, DNA, RNA, etc.). Using the present disclosure, one may create an electrophoresis gel so that the target material may be separated from other materials with reference to its size and/or molecular weight. This may involve performing electrophoresis, such as by subjecting the target material in mixture to an electric field to separate at least a portion of the target material from the mixture. The gel may be subjected to electrophoresis such that the components of a sample loaded into the gel are spread apart into distinct bands. Using a gel processing system according to any of the embodiments, a target band containing the target material may be located and excised or separated from the surrounding gel. Once excised from the surrounding gel, the target band may then be broken into fragments to aid in lysing or otherwise removing the gel material of the target band from the target component or material. One may wish to bind, wash, and elute the target material according to any of the descriptions for such procedures presented herein. After the target material has been isolated form the gel of the target band, the target material may then be subjected to further testing, analysis, or use, for example, using NextSeq sequencing.

The present disclosure provides devices, systems, and methods for gel excision and fragmentation. Such a gel excision and fragmentation method may comprise physically removing a portion of gel containing a target material from a gel that has undergone electrophoresis and, in some cases, breaking the portion of gel into smaller pieces. There are various types of methods of gel fragmentation (“gel extraction”).

In some methods of gel excision and fragmentation, a target band may be removed from an electrophoresis gel using a cutting tool such as a knife or a razor. The target band or fragments thereof that have been excised from the electrophoresis gel may then be placed inside a folded pocket of paper. The paper may be any paper, but in some cases one of that may not allow the gel to adhere or react with the paper. The paper may be a wax paper. The wax paper may comprise a paraffin film, such as Parafilm M®. Once the target band or its fragments are in the pocket of paper, the paper is physically compressed, either manually or automatically, thereby liquefying the gel and its contents. The liquefied gel droplet(s) may then be removed from the paper and stored, for instance in a small tube. The target material within the liquefied gel may then be purified. Purification of the target material may be accomplished using procedures such as ethanol precipitation (if the target material is insoluble in ethanol or isopropanol, it will aggregate together to form a pellet), phenol-chloroform extraction (to denature and remove proteins from nucleic acids, for instance), or minicolumn purification (wherein some materials preferentially bind to a surface given certain pH and ionic concentrations).

As an alternative or in addition to, a target band (or fragments thereof) excised from an electrophoresis gel may be placed into a dialysis tube that is permeable to fluids but impermeable to molecules the size of the target component. The dialysis tube may then be soaked in a solution (such as Tris(hydroxymethyl)aminomethane ethylenediaminetetraacetic acid buffer (TE buffer)) and subjected to an electrical field. The electric field may cause the target material to migrate out of the target band gel into the solution. The solution will contain the target material with very minimal background material.

As an alternative or in addition to, a portion of the gel (or fragments thereof) may then be placed into a container and the portion of the gel may then be placed in contact with a buffer to dissolve (or lyse) the gel. The portion of gel that has now been dissolved may then be used to bind the target material to a matrix, such as within a spin column. The matrix of bound target material may then be washed. Once washed, the matrix of bound target material may be eluted until all or substantially all that remains is a purified form of the target material. Between any of the operations listed above may be a centrifuging operation wherein any component may be centrifuged, a vortexing operation wherein any component may be vortexed, an incubating operation wherein any component may be incubated, and/or a compensating operation wherein the presence, absence, and/or one or more properties of any component may be compensated by, for example, adding a component, warming the solution, etc. For example, between the binding of the target material to a matrix and the washing of the matrix of bound target, the container containing the target material matrix may be spun within a centrifuge.

An example of a spin column gel processing method comprises excising a band from a gel with any of the devices or systems described herein and breaking the excised band to create a gel fragments, weighing the gel fragment(s) contained within a container, adding an amount of buffer to the container containing the gel fragment(s), incubating the gel fragment(s) and buffer at 50° C. for 10 min (or until the gel fragment completely dissolves) and vortex periodically (every 1 or 2 or 3 or 4 or 5 minutes) to help the gel fragment(s) dissolve (if the solution containing the dissolved gel fragment(s) does not exhibit a desired characteristic, such as color, pH, etc., adding a component to the solution to compensate for or provide the desired characteristic), adding a volume of isopropanol about equal to the volume of the dissolve gel fragment(s), placing the dissolved gel solution into a spin column having a manifold and then either centrifuging for 1 or 2 or 3 minutes or applying a vacuum to the manifold of the spin column until all or nearly all materials have passed through the column to create a matrix of bound target material, discarding flow-through and centrifuging or applying a vacuum to the spin column containing the matrix of bound target material as needed, adding one or more buffers sequentially to the spin column containing the matrix of bound target material and centrifuging, vacuuming, and discarding flow-through for each buffer as it is added to the spin column, and recovering purified target material.

The purified target materials that remain from any of the fragmentation or purification techniques described herein may then undergo subsequent processing methods including but are not limited to such techniques as amplification, cloning, dyeing, mass spectrometry, polymerase chain reaction, restriction fragment length polymorphism, sequencing, Southern blotting, tagging with a ligand, subjected to one or more assays, tagging for fluorescent imaging, or any combination thereof. Types of sequencing include but are not limited to Illumina next-generation sequencing techniques such as 16S metagenomics sequencing, bacterial genome sequencing, DNA sequencing, HiSeq sequencing, miRNA sequencing, MiSeq sequencing, NextSeq sequencing, PCR amplicon sequencing, and strand specific RNA sequencing. Sequencing may be Sanger sequencing. Sequencing may be next generation sequencing (NGS). Sequencing may be single molecule or massively parallel sequencing.

An aspect of the present disclosure provides a gel excision and fragmentation device. The gel excision and fragmentation device may comprise a receptacle shaped to receive a band from a gel. The receptacle may comprise a cutting edge shaped to cut the band from the gel when pressed thereon. The cutting edge of the receptacle may comprise a free angle and a rake angle, both about 0° so that the cutting edge is essentially dull to touch, but which may cut and/or break through gel. The cutting edge may be pressed onto the gel manually (e.g., by hand) or using an actuator. This may urge the cut band into the sample receptacle. The receptacle may have a length between a proximal end of the receptacle and a distal end of the receptacle sufficient to hold at least a portion of an extracted gel band within the receptacle. The length may be sufficient to hold most or all of the portion of the extracted gel band within the receptacle. The receptacle may be shaped to hold a single band of target components. The single band of target components may comprise a part of a plurality of bands generated during electrophoresis. The target components may comprise DNA, RNA, protein, or molecular fragments, or any combination thereof. The gel excision and fragmentation device may also include a fragmentation membrane having a first end operatively coupled to an end of the receptacle opposite the cutting edge and a second end, and a coupler operatively coupled to the second end of the fragmentation membrane. The fragmentation membrane may be configured to break down the received band of gel into smaller pieces and may comprise one or more holes to aid in breaking down the received band of gel by acting as a sieve through which the gel passes. The coupler may have an inner surface and an outer surface, with the inner surface or the outer surface, or any combination thereof, providing a region configured to couple to a receiving container. The gel excision and fragmentation device (including the receptacle, the fragmentation membrane, and the coupler) may comprise a single, integral unit, made of a biologically inert, non-catalyzing, or non-reactive material.

An aspect of the present disclosure provides a system for processing a band excised from a gel. The system may comprise a gel excision and fragmentation device comprising a receptacle shaped to receive a band from a gel, the receptacle having a cutting edge shaped to cut the band from the gel when pressed thereon, thereby urging the cut band into the receptacle and a fragmentation membrane having a first end operatively coupled to an end of the receptacle opposite the cutting edge and a second end. The gel excision and fragmentation device may comprise a coupler operatively coupled to the second end of the fragmentation membrane.

The system may also include a receiving container. The receiving container may comprise a centrifuge tube with an open boundary at a distal end thereof and a closed boundary at a proximal end thereof. The receiving container may comprise an Eppendorf tube.

The coupler of the gel excision and fragmentation device may be configured to couple to the receiving container via an interference fit between the coupler of the gel excision and fragmentation device and the receiving container. Coupling of the gel excision and fragmentation device and the receiving container may be aided by a locking mechanism disposed on the coupler of the gel fragmentation device.

The system may be configured to be manipulated by a user to cut a target band from a gel. Furthermore, the system may be configured to be disposed within a centrifuge.

During use, the cutting edge of the receptacle of the gel excision and fragmentation device may be pressed against the gel to cut the gel band from the gel. This may urge the cut gel band into the receptacle, which may be captured. Next, the coupler of the gel excision and fragmentation device may be coupled with an opening of the receiving container. Next, the coupled gel excision and fragmentation device may be centrifuged. The container containing the captured gel band may then be received.

In some cases, centrifuging the coupled gel excision and fragmentation device comprises forcing the captured gel band through the fragmentation membrane of the gel excision and fragmentation device. This may break the captured gel band into gel fragments. The gel fragments may then be collected in the receiving container.

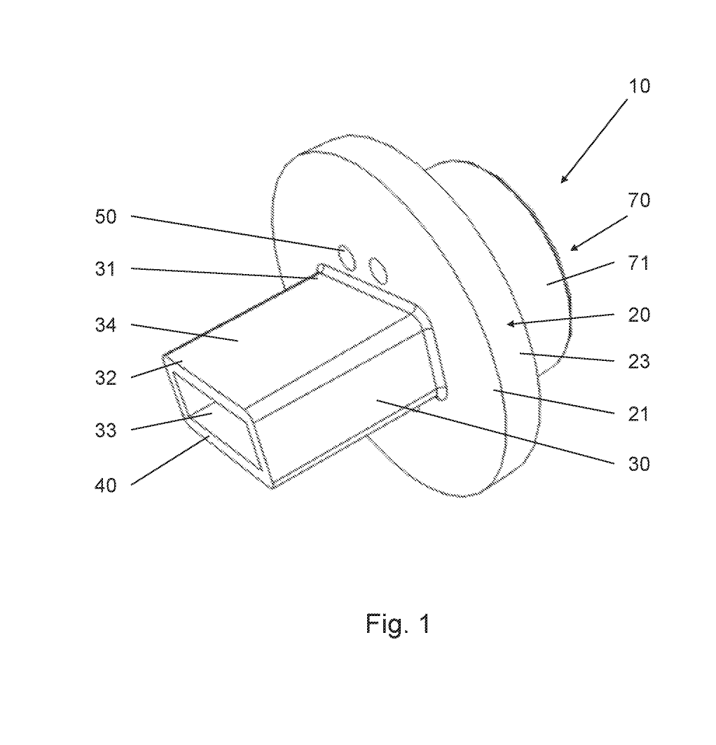

FIG. 1 shows a perspective view of an exemplary embodiment of a gel excisor emphasizing the coupler. The gel excisor 10 may comprise a base 20 with an anterior surface 21, a posterior surface and a side edge 23, a receptacle 30 to receive excised gel, the receptacle having a proximal end 31 and a distal end 32, a cutting edge 40 to cut into a gel, vent holes 50, a fragmentation membrane with fragmentation membrane holes, an anterior surface, and a posterior surface, and a coupler 70 with an outer surface 71 and an inner surface. The gel excisor 10 may be made of any biologically inert, non-catalyzing, or non-reactive material such as many plastics. Such biologically inert, non-catalyzing, or non-reactive materials include but are not limited to acrylic, acrylonitrile butadiene styrene, bakelite, duroplast, nylon, polyactide, polybenzimidazole, polycarbonate, polycyanurates, polyester, polyether sulfone, polyether ether ketone, polyetherimide, polyethylene, polyimide, polyphylene oxide, polyphenylene sulfide, polypropylene, polystyrene, polyurethane, polyvinyl chloride, Teflon, and vulcanized rubber. One of skill in the art will recognize that such a list is not exhaustive, but illustrative. Moreover, the gel excisor may comprise a metal (such as aluminum, brass, copper, iron, magnesium, steel, zinc), a ceramic (such as zirconium dioxide), and/or organic materials (such as animal- or plant-based materials). The base 20 may be any of a number of shapes including a circle, an ellipse, a rectangle, or a triangle. The base 20 may have a profile that matches the shape of a container it is meant to couple to, though it may be scaled to be smaller or larger than the container's shape. The base 20 may have a profile meant to aid in gripping. Such a base 20 profile may comprise one or more grooves, one or more protrusions, one or more wavy patterns, or at least a portion of the base 20 textured, or any combination thereof. The anterior surface 21 of the base 20 may be smooth or textured to suit the specific task and/or environment the gel excisor is employed to. In some embodiments, the receptacle 30 is shaped to hold a single band of deoxyribonucleic acid (DNA), ribonucleic acid (RNA), protein, or molecular fragments, or any combination thereof, said band possibly being part of a collection of similar bands created during electrophoresis. In other embodiments, the cross-sectional shape of the receptacle 30 may take on any number of shapes including a circle, an ellipse, a rectangle, or a triangle. The cross-sectional shape of the receptacle 30 may take on any shape defined by the sum of one or more sine or cosine functions. The receptacle 30 may have a length between its proximal end 31 and its distal end 32 sufficient to hold at least some portion of the extracted gel band within an inner surface 33 of the receptacle 30. Disposed at the distal end of the receptacle may be the cutting edge 40, which may be pressed against the gel to separate the desired band from the rest. The profile of the cutting edge 40 may take on a wide variety of cutting edge geometries, such as a round or waterfall hone, a wide variety of free and rake angles, such as the pairing of a free and rake angle each of 0° so that the cutting edge 40 may be substantially parallel to the gel surface when used to cut the gel and essentially dull to the touch, and a wide variety of chamfer and/or fillet forms and sizes to assist in the structural or functional integrity of the device. The cutting edge 40 may comprise a saw tooth pattern. The coupler 70 may be shaped such that either its outer surface 71 or inner surface corresponds to a complementary surface on a receiving container. The outer surface 71 or the inner surface may be smooth or textured to suit the specific task and/or environment the gel excisor is employed to. Such textured patterns may include knurling, screw-like threads, or any other pattern that may aid in the coupling of the device 10 to a receiving container. The length of the coupler 70 should be such that at least a portion of the coupler 70 overlaps with at least a portion of receiving container it is meant to couple with.

The gel excisor 10 may be manufactured using one or more of the following procedures in individually and/or in combination (in series and/or in parallel): additively manufactured (such as three-dimensional (3D) printing, composite material winding, digital light processing, direct metal laser sintering, electronic beam melting, fused deposition modeling, laminated object manufacturing, laser powder forming, selective laser melting, selective laser sintering, stereolithography), casting (such as centrifugal casting, continuous casting die casting, evaporative-pattern casting, investment casting, permanent mold casting, resin casting, sand casting, shell molding, slurry casting, spray forming, vacuum molding), coating (such as chemical vapor deposition, inject printing, laser engraving, sputter deposition), forming (such as bending, coining, extruding, forging, piercing, pressing, rolling, shearing, stamping), joining (such as brazing, fastening, press fitting, sintering, soldering, welding), machining (such as broaching, drilling, electrical discharge machining, electron beam machining, electrochemical machining, filing, finishing, grinding, honing, milling, planning, reaming, sawing, shaping, turning), molding (such as blow molding, compaction plus sintering, compression, dip molding, extrusion, hot isostatic pressing, injecting molding, laminating, rotational molding, shrink fitting/wrapping, spray forming, thermoforming).

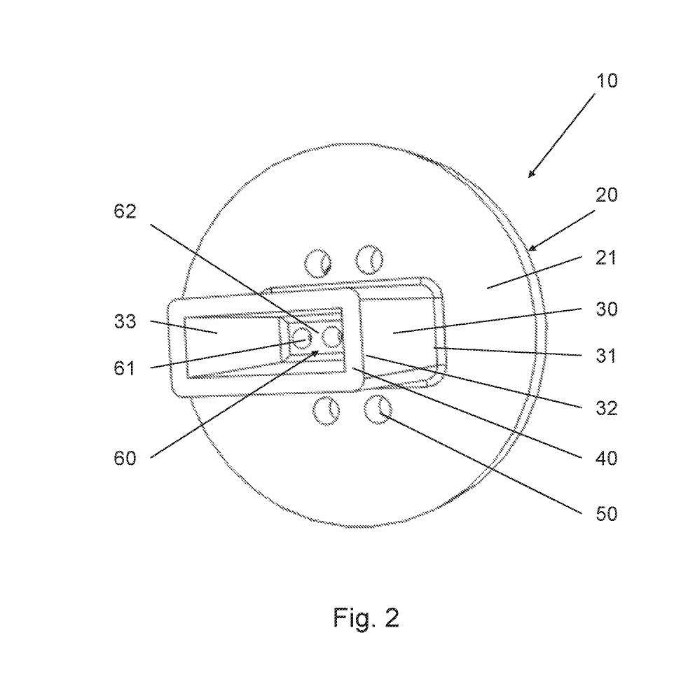

FIG. 2 shows a perspective view of the gel excisor 10 of FIG. 1, emphasizing its fragmentation membrane 60. The fragmentation membrane 60 may comprise fragmentation membrane holes 61, an anterior surface 62, and a posterior surface. Disposed at the proximal end of the receptacle, the fragmentation membrane 60 may be such that as gel crosses from the anterior surface 62 to the posterior surface, the gel is cut into, broken into, and/or made to become smaller pieces. Holes 61 in the fragmentation membrane 60 may aid in breaking up the gel into smaller pieces by acting as a sieve through which the gel passes. The holes 61 in the fragmentation membrane 60 may be of any size or shape capable of allowing gel and/or target material to pass through. Possible shapes of the cross-section of the holes 61 of the fragmentation membrane 60 include but are not limited to a circle an ellipse, a triangle, a rectangle, a polygon, or any combination thereof, and may be spatially dispersed to maximize their effect (such as in a linear manner, a radially symmetric manner, etc). Possible sizes for the holes 61 of the fragmentation membrane 60 include but are not limited to cross-sectional diameters of at least about 10 micrometers (μm), 25 μm, 50 μm, 100 μm, 200 μm, 250 μm, 500 μm, 1 millimeter (mm), 2 mm, 5 mm, or 10 mm, or it may take on any value in between any two of the values listed. One or more of the fragmentation membrane holes 61 may have a cross-section of at most about 10 mm, 5 mm, 2 mm, 1 mm, 500 μm, 250 μm, 200 μm, 100 μm, 50 μm, 25 μm, 10 μm, or it may take on any value in between any two of the values listed. The number of holes 61 in the fragmentation membrane 60 may be about 1, 2, 3, 4, 5, 6, 7, 8, 9 10, 11, 12, 13, 14, 15, 16, 17, 18, 19, 20, 21, 22, 23, 24, 25, 26, 27, 28, 29, 30, 40, 50, 60, 70, 80, 90, 100, or it may take on any value in between any two of the values listed. There may be at least one vent hole 50 to facilitate optimally transferring material across the fragmentation membrane 60 from the fragmentation membrane's anterior surface 62 to its posterior surface by allowing any air, liquid, or fluid on the posterior side of the base 20 or the fragmentation membrane 60 to traverse through at least one vent hole 50. The number of vent holes 50 may be about 1, 2, 3, 4, 5, 6, 7, 8, 9 10, 11, 12, 13, 14, 15, 16, 17, 18, 19, 20, 21, 22, 23, 24, 25, 26, 27, 28, 29, 30, 40, 50, 60, 70, 80, 90, 100, or it may take on any value in between any two of the values listed. Traversing through at least one vent hole 50 may comprise passing material from a posterior surface to an anterior surface and/or passing material from an anterior surface to a posterior surface. The vent holes 50 may take on any shape including a circle, an ellipse, a triangle, a rectangle, a polygon, or any combination thereof and may be spatially dispersed to maximize their effect (such as in a linear manner, a radially symmetric manner, etc.). The vent holes 50 may have various sizes. For example, one or more of the vent holes may have a cross-section of at least about 10 μm, 25 μm, 50 μm, 100 μm, 200 μm, 250 μm, 500 μm, 1 mm, 2 mm, 5 mm, or 10 mm, or it may take on any value in between any two of the values listed. One or more of the vent holes 50 may have a cross-section of at most about 10 mm, 5 mm, 2 mm, 1 mm, 500 μm, 250 μm, 200 μm, 100 μm, 50 μm, 25 μm, 10 μm, or it may take on any value in between any two of the values listed.

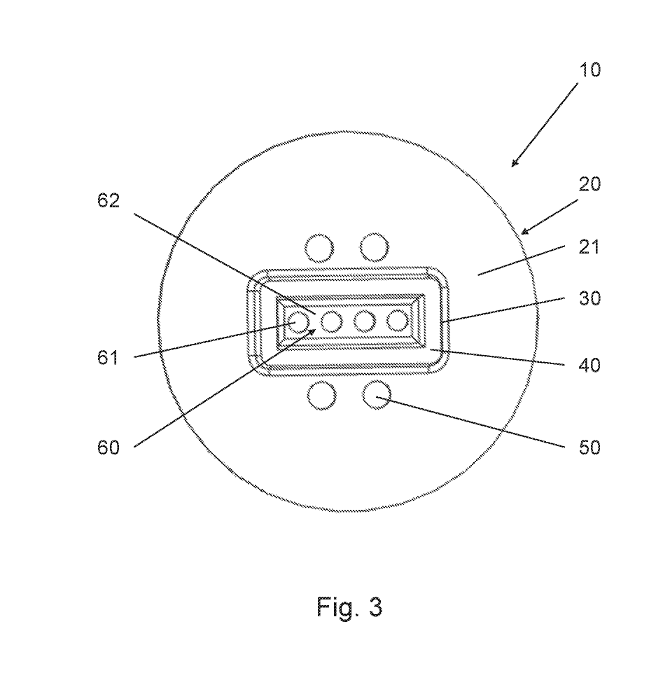

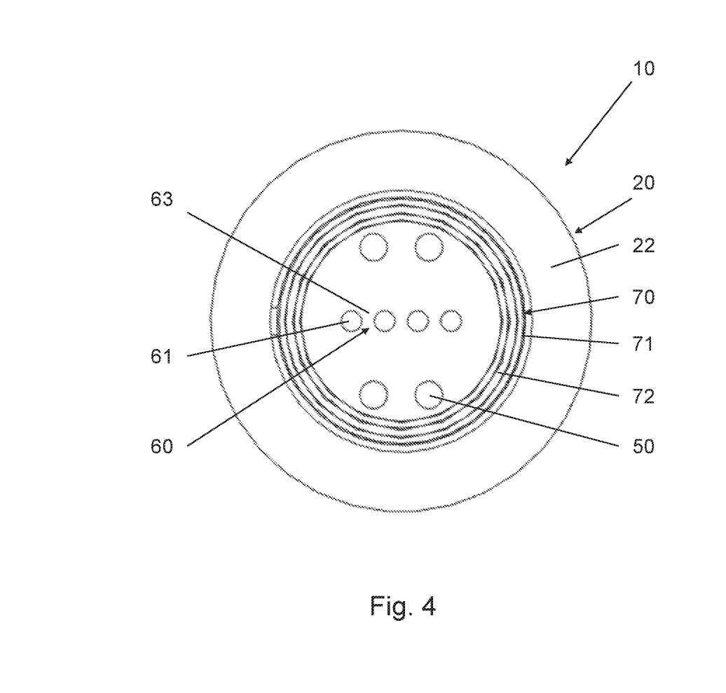

FIGS. 3 and 4 are front and back views of a gel excisor 10. FIG. 3 shows the front view of the gel excisor 10 of FIG. 1. FIG. 4 shows the back view of the gel excisor 10. A posterior surface 22 of the base 20 may be smooth or textured to suit the specific task and/or environment the gel excisor is employed to. The posterior surface 63 of the fragmentation membrane 60 may further be configured to prevent the flow of material from the posterior surface 63 to the anterior surface 62 of the fragmentation membrane. There may be at least one vent hole 50 to facilitate optimally transferring material across the fragmentation membrane 60 from the fragmentation membrane's anterior surface to its posterior surface 63 by allowing any air, liquid, or fluid on the posterior side of the base 20 or the fragmentation membrane 60 to traverse through a vent hole 50. The vent holes 50 may take on any shape including a circle, an ellipse, a triangle, a rectangle, a polygon, or any combination thereof and may spatially dispersed to maximize their effect (such as in a linear manner, a radially symmetric manner, etc.).

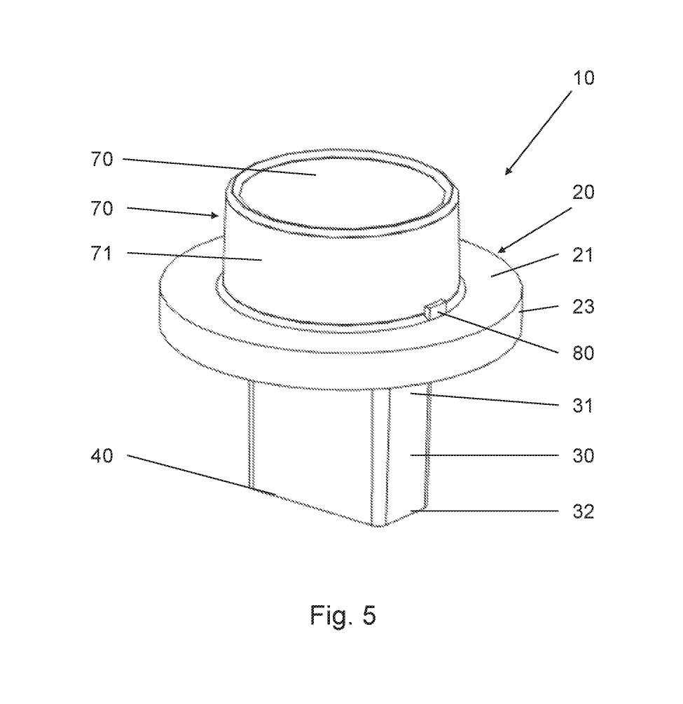

FIG. 5 shows a perspective view of an exemplary embodiment of a gel excisor 10 of FIG. 1, emphasizing a locking mechanism. The locking mechanism 80 may assist in coupling the gel excisor 10 to a receiving container, may prevent the gel excisor 10 from become dislodged during use, and/or may help to keep any contents contained within the receiving container contained within the receiving container. The locking mechanism 80 may optimize an interference fit, provide screw-like threads for engagement, or provide a small amount of adhesive, or any combination thereof.

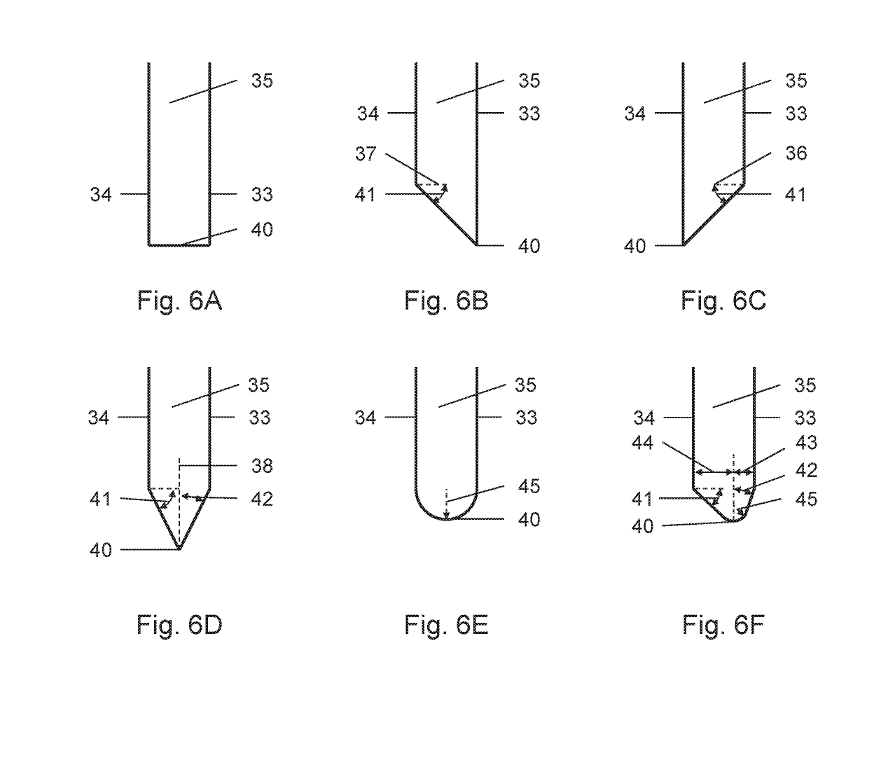

FIGS. 6A-6F show cross-sectional views of a receptacle wall 35 emphasizing a cutting edge 40. A simple cross-sectional view was chosen for clarity, though it will be appreciated that the receptacle wall 35 may take on any shape as specified within the body of this detailed description including but not limited to a circle, a triangle, a rectangle, a trapezoid, a polygon, or a profile whose shape may be defined by the summation of any number sine and cosine functions, or any combination thereof. The receptacle wall 35 may be any wall of the receptacle. For each of the illustrated cases, the cutting edge 40 will be disposed at a distal end of the receptacle; however, the actual position of the cutting edge 40 with respect to the receptacle may be any of those disclosed herein.

FIG. 6A shows the receptacle wall 35 with an inner surface 33 corresponding to that portion of the receptacle which is to receive the target gel and an outer surface 34 corresponding to that portion of the receptacle which does not receive the target gel band. At the distal end of the receptacle wall is a cutting edge 40 that is about flat and would be essentially dull to the touch.

FIG. 6B shows a receptacle wall 35 with a cutting edge 40 formed with a rake angle 41. Here, the rake angle 41 may be defined as the angle formed between the cutting edge 40 and an axis 37 perpendicular to the outer wall 34. In general, the rake angle 41 describes the angle of the cutting edge 40 with respect to that which is to be cut. The rake angle 41, here and elsewhere, may be zero, acute, right, or obtuse. The rake angle 41, here and elsewhere, may be zero, positive, or negative. The rake angle 41 of the cutting edge 40 may help to cut through gel, separate a target band from the rest of the matrix, or remove the target band from the receptacle. Forming the cutting edge with a rake angle with respect to the outer wall 34 may provide a sharper cutting edge 40, making it easier for a user to cut into a gel to extract a target band.

FIG. 6C shows a receptacle wall 35 with a cutting edge 40 formed with a rake angle 41, the rake angle 41 here defined as the angle formed between the cutting edge 40 and an axis 36 perpendicular to the inner wall 33. The rake angle 41 may be zero, acute, right, or obtuse; zero, positive, or negative; and/or formed with respect to the inner wall 33 or the outer wall 34. Forming the cutting edge with a rake angle with respect to the inner wall 33 may provide a sharper cutting edge 40, making it easier for a user to cut into a gel to extract a target band.

FIG. 6D shows a receptacle wall 35 with a cutting edge 40 formed with a rake angle 41 defined as the angle formed between the cutting edge 40 and an axis 37 perpendicular to the outer wall 34 and a relief angle 42 defined as the angle formed between the cutting edge 40 and an axis 38 parallel to the inner wall 33 passing through the cutting edge 40. Though the illustrated embodiment shows and defines the rake angle 41 and the relief angle 42 with respect to the outer wall 34 and inner wall 33, respectively, it will be understood that analogous relationships defining the rake angle 41 and the relief angle 42 with respect to the inner wall 33 and the outer wall 34, respectively, are also intended. Having the combination of a rake angle 41 and a relief angle 42 may provide a sharper cutting edge 40 to make it easier to cut into a gel to extract a target band. The relief angle 42 may help relieve stress, strain, pressure, and/or forces acting on the cutting edge 40 and/or at any point on the receptacle.

FIG. 6E shows a receptacle wall 35 with a cutting edge 40 having a cutting edge radius 45. The cutting edge radius 45 of this or any embodiment may be at least about 1 μm, 5 μm, 10 μm, 20 μm, 25 μm, 50 μm, 100 μm, 200 μm, 250 μm, 500 μm, 1 mm, 1.1 mm, 1.2 mm, 1.25 mm, 1.5 mm, 2 mm, 5 mm, 10 mm, 25 mm, 100 mm, 200 mm, 250 mm, 500 mm, or 1 m, or it may take on any value in between any two of the values listed. The cutting edge radius 45 of this or any embodiment may be at most about 1 μm, 5 μm, 10 μm, 20 μm, 25 μm, 50 μm, 100 μm, 200 μm, 250 μm, 500 μm, 1 mm, 1.1 mm, 1.2 mm, 1.25 mm, 1.5 mm, 2 mm, 5 mm, 10 mm, 25 mm, 100 mm, 200 mm, 250 mm, 500 mm, or 1 m, or it may take on any value in between any two of the values listed. The cutting edge radius 45 of this or any embodiment may be about 1 μm, 5 μm, 10 μm, 20 μm, 25 μm, 50 μm, 100 μm, 200 μm, 250 μm, 500 μm, 1 mm, 1.1 mm, 1.2 mm, 1.25 mm, 1.5 mm, 2 mm, 5 mm, 10 mm, 25 mm, 100 mm, 200 mm, 250 mm, 500 mm, or 1 m, or it may take on any value in between any two of the values listed.

FIG. 6F shows an exemplary embodiment of a receptacle wall 35 with cutting edge 40 having a rake angle 41, a relief angle 42, and cutting edge radius 45. The cutting edge 40 may be a distance 43 from the inner surface 33 and a distance 44 from the outer surface 34. The distances 43, 44 from the inner surface 33 and outer surface 34 may independently or in conjunction take on any value equal to or less than a maximum width of the receptacle wall it comprises.

For all embodiments, the magnitude of rake angle and/or relief angle may be at least about 0°, 1°, 2°, 5°, 10°, 20°, 30°, 40°, 50°, 60°, 70°, 80°, 90°, 100°, 110°, 120°, 130°, 140°, 150°, 160°, 170° or 180°, or it may take on any value in between any two of the values listed, wherein the aforementioned values may be either positive or negative. For all embodiments, the magnitude of rake angle and/or relief angle may be at most about 0°, 1°, 2°, 5°, 10°, 20°, 30°, 40°, 50°, 60°, 70°, 80°, 90°, 100°, 110°, 120°, 130°, 140°, 150°, 160°, 170° or 180°, or it may take on any value in between any two of the values listed, wherein the aforementioned values may be either positive or negative. For all embodiments, the magnitude of rake angle and/or relief angle may be about 0°, 1°, 2°, 5°, 10°, 20°, 30°, 40°, 50°, 60°, 70°, 80°, 90°, 100°, 110°, 120°, 130°, 140°, 150°, 160°, 170° or 180°, or it may take on any value in between any two of the values listed, wherein the aforementioned values may be either positive or negative.

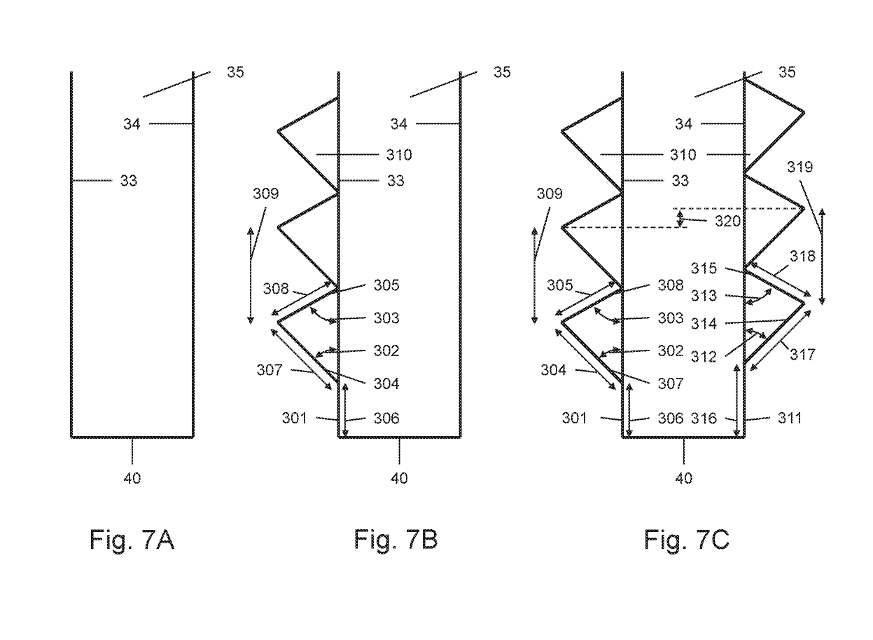

To promote preferential cutting and/or guidance of gel fragments into the receptacle and ultimately through the fragmentation membrane into a receiving container, one or more surfaces of the receptacle may have a textured or ridged region. FIGS. 7A-7C show cross-sectional views of an exemplary embodiment of such a feature on a receptacle wall 35. A simple cross-sectional view was chosen for clarity, though it will be appreciated that the receptacle wall 35 may take on any shape as described herein. The receptacle wall 35 may be any wall of the receptacle.

The textured or ridged region may be disposed on one or more of the surfaces of the receptacle. In some embodiments, the textured or ridged region may be disposed on all inner surfaces of the receptacle. In some embodiments, the textured or ridged region may be disposed on all outer surfaces of the receptacle. In some embodiments, the textured or ridged region may be disposed on all surfaces of the receptacle. The surfaces of any embodiment may comprise curved ridges, rectangular ridges, a patterned surface, a roughed surface, a knurled surface, and/or any surface that would increase an area of contact between a gel fragment and a receptacle surface, increase the effective friction between a gel fragment and a receptacle surface, and/or promote preferential movement of a gel fragment from a distal end of a receptacle to its proximal end.

In the exemplary embodiment of FIG. 7A, a receptacle wall 35 is comprised of an inner surface 33 and an outer surface 34. The inner surface 33 and/or the outer surface 34 may have a coating disposed thereon. The coating disposed on the inner surface 33 and/or on the outer surface 34 may be hydrophilic or hydrophobic, may increase or decrease the coefficient of friction, may ensure biocompatibility of the gel excisor or any system in which it is disposed, may facilitate movement of the receptacle through a gel, may facilitate movement of a gel fragment from a distal end of the receptacle to a proximal end, and/or may increase the structural integrity of the receptacle and/or the gel excisor.

FIG. 7B shows a receptacle wall 35 with an inner surface 33 with one or more ridges 310. In the illustrated embodiment, the ridges 310 are each comprised of a first surface 304 have a length 307 and angled by a first angle 302 from the inner surface 33 and a second surface 305 having a length 308 angled by a second angle 303 from the inner surface 33. An entrance region 301 with an entrance length 306 may extend between the cutting edge 40 and one or more ridges 310. The entrance region 301 may facilitate better cutting, severing, cutting, excising, and/or removal of a target band of gel from a larger gel.

For all embodiments, the value of the first angle 302 and the second angle 303 may each be at least 0°, 1°, 2°, 5°, 10°, 20°, 30°, 40°, 50°, 60°, 70°, 80°, 90°, 100°, 110°, 120°, 130°, 140°, 150°, 160°, 170° or 180°, or it may take on any value in between any two of the values listed, wherein the aforementioned values may be either positive or negative. For all embodiments, the value of the first angle 302 and the second angle 303 may each be at most about 0°, 1°, 2°, 5°, 10°, 20°, 30°, 40°, 50°, 60°, 70°, 80°, 90°, 100°, 110°, 120°, 130°, 140°, 150°, 160°, 170° or 180°, or it may take on any value in between any two of the values listed, wherein the aforementioned values may be either positive or negative. For all embodiments, the value of the first angle 302 and the second angle 303 may each be about 0°, 1°, 2°, 5°, 10°, 20°, 30°, 40°, 50°, 60°, 70°, 80°, 90°, 100°, 110°, 120°, 130°, 140°, 150°, 160°, 170° or 180°, or it may take on any value in between any two of the values listed, wherein the aforementioned values may be either positive or negative.

FIG. 7C shows a receptacle wall 35 with an inner surface 33 and an outer surface 34, each with one or more ridges 310. In the illustrated embodiment, the ridges 310 of the inner surface 33 are each comprised of a first surface 304 have a length 307 and angled by a first angle 302 from the inner surface 33 and a second surface 305 having a length 308 angled by a second angle 303 from the inner surface 33. An entrance region 301 on the inner surface 33 with an entrance length 306 may extend between the cutting edge 40 and one or more ridges 310 on the inner surface 33. Similarly, the ridges 310 of the outer surface 34 are each comprised of a first surface 314 have a length 317 and angled by a first angle 312 from the outer surface 34 and a second surface 315 having a length 318 angled by a second angle 313 from the outer surface 34. Ridges 310 on the outer surface 34 may help a user to apply or remove the gel excisor from a receiving container, may aid in cutting, fragmentation, or containment of a target gel band from a gel, and/or may help to strengthen the receptacle. An entrance region 311 on the outer surface 34 with an entrance length 316 may extend between the cutting edge 40 and one or more ridges 310 on the outer surface 34. The entrance length 316 of the outer surface 34 may by greater than, equal to, or less than the entrance length 306 of the inner surface 33. Such a difference in entrance lengths 306, 316 may aid in cutting, fragmentation, or containment. One or more ridges 310 of the inner surface 33 and the outer surface 34 may be offset by a distance 320. Such an offset distance 320 may aid in cutting, fragmentation, or containment.

For all embodiments, the value of the first angle 312 and the second angle 313 may each be at least 0°, 1°, 2°, 5°, 10°, 20°, 30°, 40°, 50°, 60°, 70°, 80°, 90°, 100°, 110°, 120°, 130°, 140°, 150°, 160°, 170° or 180°, or it may take on any value in between any two of the values listed, wherein the aforementioned values may be either positive or negative. For all embodiments, the value of the first angle 312 and the second angle 313 may each be at most about 0°, 1°, 2°, 5°, 10°, 20°, 30°, 40°, 50°, 60°, 70°, 80°, 90°, 100°, 110°, 120°, 130°, 140°, 150°, 160°, 170° or 180°, or it may take on any value in between any two of the values listed, wherein the aforementioned values may be either positive or negative. For all embodiments, the value of the first angle 312 and the second angle 313 may each be about 0°, 1°, 2°, 5°, 10°, 20°, 30°, 40°, 50°, 60°, 70°, 80°, 90°, 100°, 110°, 120°, 130°, 140°, 150°, 160°, 170° or 180°, or it may take on any value in between any two of the values listed, wherein the aforementioned values may be either positive or negative.

Any aspects of the aforementioned exemplary embodiments may be used in combination with any other aspects. Each of the aspects, elements, and/or facets of the gel excisor 10 described herein may comprise a single integral piece or they may constitute one or more distinct pieces that comprise the gel excisor 10.

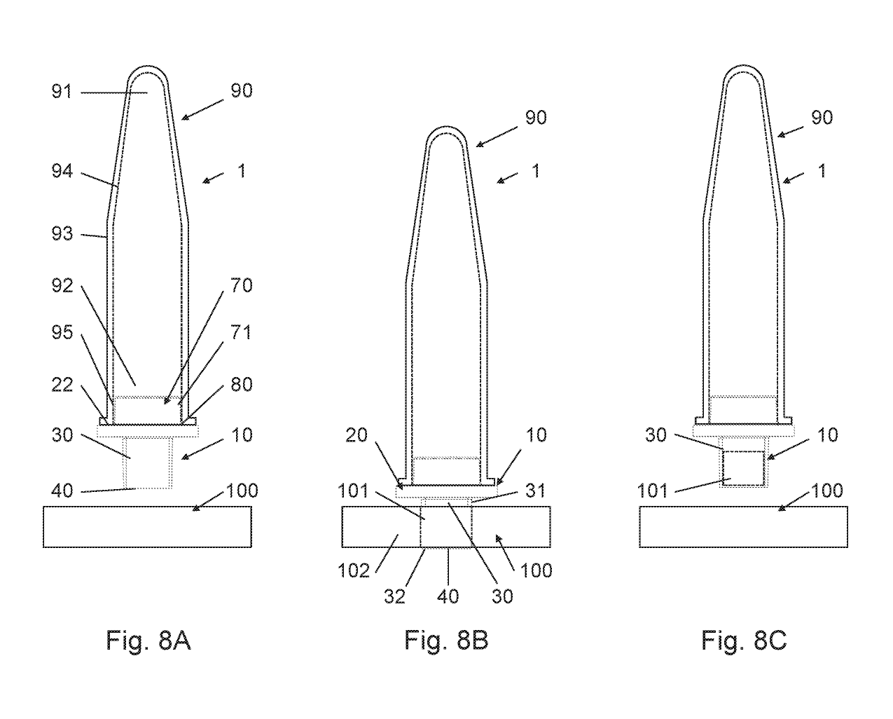

FIGS. 8A-8C show an exemplary method of gel fragmentation using gel excision and fragmentation devices according to embodiments. FIG. 8A shows a gel fragmentation system 1 that may be poised over a gel 100. The gel fragmentation system 1 may comprise the gel excisor 10 as described herein. The gel fragmentation system 1 may further comprise a receiving container 90 which has a proximal end 91 which has a closed boundary, a distal end 92 which has an open boundary, an outer surface 93, and an inner surface 94; and a gel 100. The gel excisor 10 and the receiving container 90 may be coupled together along a coupling zone 95 in which the outer surface 71 of the gel excisor 10 coupler 70 is in contact with either the inner surface 94 of the distal end 92 of the receiving container 90 (as illustrated) or the outer surface 93 of the distal end 92 of the receiving container 90. The gel excisor 10 and the receiving container 90 may be coupled via an interference fit, threadably engaged, or bonded with an adhesive, or any combination thereof. The coupling of the gel excisor 10 and the receiving container 90 may be further enhanced by the presence of a locking mechanism 80 which may optimize an interference fit, provide screw-like threads for engagement, or provide a small amount of adhesive, or any combination thereof. In an exemplary embodiment the gel excisor 10 would couple with the receiving container 90 such that the distal end 92 of the receiving container 90 would contact the anterior surface 22 of the gel excisor base 20. Such contact may aid in the structural and/or functional stability of the system.

The receiving container 90 may comprise a centrifuge tube, a microcentrifuge tube, or any container able to be disposed within a centrifuge. The volume of the receiving container 90 may be 10 μL, 25 μL, 50 μL, 100 μL, 150 μL, 200 μL, 250 μL, 500 μL, 1 mL, 1.5 mL, 2 mL, 5 mL, 10 mL, 25 mL, 50 mL, 100 mL, 150 mL, 200 mL, 250 mL, 500 mL, or 1 L, or it may take on any value in between any two of the values listed. The receiving container 90 may be made of any biologically inert, non-catalyzing, or non-reactive material, such as those described previously. The receiving container 90 may comprise any material listed within this specification, plastic, glass, ceramic, or metal, or any combination thereof. In some embodiments, the receiving container 90 comprises a flexible, transparent plastic. In some embodiments, the receiving container may comprise a lid or cap (not illustrated) that may integral with or couple to the receiving container 90.

The receiving container 90 may have a coating on its inner surface 94 to ensure biological inertness, to minimize possible catalysis between any material contained within the receiving container 90 and the material of the receiving container, to minimize any possible reaction between any material contained within the receiving container 90 and the material of the receiving container, to facilitate transfer of material into and/or out of the receiving container 90 such as a coating that prevents or lowers the possibility and/or the effects of materials sticking to the inner surface 94 of the receiving container 90.

The receiving container 90 may take on any number of shapes including a circle, an ellipse, a triangle, a rectangle, or a polygon, or any combination thereof. The receiving container 90 may be shaped to correspond with the shape of the gel excisor 10.

Each of the aspects, elements, and/or facets of the receiving container 90 described herein may comprise a single integral piece or they may constitute one or more distinct pieces that comprise the receiving container 90.

A user of the gel fragmentation system 1 may position the system above or below the gel 100 such that a projection of the boundary of the cutting edge 40 onto the gel 100 partially or fully surrounds a target band within the gel 100. This process may be executed either manually or facilitated by some form of automation such as location determination via computer vision, system manipulation and/or positioning via robotic control, or with a grid-based system for position determination, or any combination thereof. Once a target band has been identified and the gel fragmentation system 1 positioned to the desired location, the gel fragmentation system 1 may thus be pressed into the gel 100 to excise the target band.

FIG. 8B shows a gel fragmentation system 1 cutting into a gel 100. Once a target band has been identified and the gel fragmentation system 1 has been positioned to a desired location, the system 1 may be pressed into the gel 100 to excise the target band. The gel fragmentation system 1 may be pressed down onto the gel 100, the gel 100 may be pressed up into the system 1, the system 1 may be pressed up onto the gel 100, or the gel 100 may be pressed down onto the system 1, or any combination thereof, to facilitate cutting of the gel 100 by the cutting edge 40 of the gel excisor 10. Pressing the gel fragmentation system 1 into the gel 100 allows the cutting edge 40 of the gel excisor 10 to cut into the gel 100, separating the target band 101 from the surrounding gel 102. Pressing the gel fragmentation system 1 into the gel 100 may allow the cutting edge 40 of the gel excisor 10 to cut into the gel 100, urging the target band 101 from the distal end 32 of the receptacle 30 towards the proximal end 31 of the receptacle 30. When cutting into the gel 100 to remove a target band 101, the cutting edge 40 of the gel excisor 10 may traverse the entire thickness of the gel 100 or it may travel some partial thickness of the gel 100 so that the target band 101 is sufficiently separated from the surrounding gel 102 and able to be excised from the gel 100. The cutting process may be performed either manually or facilitated by some form of automation such as location determination via computer vision, system manipulation and/or positioning via robotic control, or with a grid-based system for position determination, or any combination thereof.

FIG. 8C shows the gel fragmentation system 1 excising a target band 101 from a gel 100. During excision, a target band 101 of material from the gel 100 can be disposed in the receptacle 30 of the gel excisor 10. The target band 101 may be either fully or partially contained within the receptacle 30.

Any gel matrix described herein may at any point before, during, or after gel fragmentation may comprise at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 lanes. The electrophoresis matrix can comprise about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 lanes. The electrophoresis matrix may comprise less than any of the number of lanes described, or a number of lanes falling within a range between any two of the values described.

Matrix or gel lanes may comprise different geometrical configurations. Matrix or gel lanes may be parallel with respect to each other. Matrix or gel lanes may be non-parallel with respect to each other. Matrix or gel lanes may have a common width or may vary in width. Matrix or gel lanes may have a common length or may vary in length. Matrix or gel lanes may extend for about 100%, 90%, 80%, 70%, 60%, or 50% of the length of the frame. Matrix or gel lanes may extend for at least about 100%, 90%, 80%, 70%, 60%, or 50% of the length of the frame. Matrix or gel lanes may extend for at most about 100%, 90%, 80%, 70%, 60%, or 50% of the length of the frame. Matrix or gel lanes may have a width of about 0.1, 0.5, 1, 2, 3, 4, 5, 6, 7, 8, 9, 10, 11, 12, 13, 14, 15, 16, 17, 18, 19, 20, 25, 30, 35, 40, 45, or 50 mm. Matrix or gel lanes may have a width of at least about 0.1, 0.5, 1, 2, 3, 4, 5, 6, 7, 8, 9, 10, 11, 12, 13, 14, 15, 16, 17, 18, 19, 20, 25, 30, 35, 40, 45, or 50 mm. Matrix or gel lanes may have a width of at most about 0.1, 0.5, 1, 2, 3, 4, 5, 6, 7, 8, 9, 10, 11, 12, 13, 14, 15, 16, 17, 18, 19, 20, 25, 30, 35, 40, 45, or 50 mm. Matrix or gel lanes may have a length of about 1, 2, 3, 4, 5, 6, 7, 8, 9, 10, 15, 20, 25, 30, 35, 40, 45, or 50 cm. Matrix or gel lanes may have a length of at least about 1, 2, 3, 4, 5, 6, 7, 8, 9, 10, 15, 20, 25, 30, 35, 40, 45, or 50 cm. Matrix or gel lanes may have a length of at most about 1, 2, 3, 4, 5, 6, 7, 8, 9, 10, 15, 20, 25, 30, 35, 40, 45, or 50 cm.

Different gel compositions may be used. The porosity of the gel may be affected by the composition of the gel. Different porosity gels may provide improved resolution for particular size ranges of samples. Agarose gel may comprise at least about 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, or 3.5% agarose. Agarose gel may comprise at most about 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, or 3.5% agarose. Agarose gel may comprise about 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, or 3.5% agarose. In some cases, agarose gel may comprise between about 0.7% and about 2% agarose. In some cases, agarose gel may comprise between about 0.7% and about 3% agarose. Polyacrylamide gel can comprise at least about 5%, 6%, 7%, 8%, 9%, 10%, 11%, 12%, 13%, 14%, 15%, 16%, 17%, 18%, 19%, or 20% polyacrylamide. Polyacrylamide gel can comprise at most about 5%, 6%, 7%, 8%, 9%, 10%, 11%, 12%, 13%, 14%, 15%, 16%, 17%, 18%, 19%, or 20% polyacrylamide. Polyacrylamide gel can comprise about 5%, 6%, 7%, 8%, 9%, 10%, 11%, 12%, 13%, 14%, 15%, 16%, 17%, 18%, 19%, or 20% polyacrylamide. In some cases, polyacrylamide gel can comprise between about 6% and about 15% polyacrylamide. For example, between different lanes, the gel composition can vary between lanes by at least about 10%, 20%, 30%, 40%, 50%, 60%, 70%, 80%, 90%, 100%, 110%, 120%, 130%, 140%, 150%, 160%, 170%, 180%, 190%, 200%, 250%, 300%, 350%, 400%, 450%, 500%, 550%, 600%, 650%, or 700%. Between lanes, the gel composition can have porosities differing by one, two, three, four, five or more orders of magnitude. Physical barriers may be used to separate individual gel or matrix lanes of different porosities or materials.

A different percentage of polymer or a different mix of polymer can produce a gel especially suited for resolution of a particular size range. For example, 0.7% agarose gel can provide good resolution for nucleic acid fragments between about 5 and 10 kb. For example, 2% agarose gel can provide good resolution for nucleic acid fragments between about 0.2 and 1.0 kb. Gel lanes within an apparatus can be loaded with gels of different or the same type. For example, some gel lanes can be loaded with agarose gel and some lanes can be loaded with polyacrylamide gel. Gel lanes can within an apparatus can be loaded with gels of the same or of different densities or porosities. For example, some gel lanes can be loaded with a 6% polyacrylamide gel while other gel lanes are loaded with a 12% polyacrylamide gel.

Gels can comprise or be used in conjunction with buffers, reagents, detergents, dyes, and other components. Gels can comprise or be used in conjunction with denaturants for nucleic acids, such as urea, DMSO, glyoxal, or methylmercury hydroxide. Gels can comprise or be used in conjunction with denaturants for proteins, such as sodium dodecyl sulfate (SDS), beta-mercaptoethanol or dithiothreitol. Gels can comprise buffers, such as loading buffer, Tris, Bis-Tris, imidazole, EDTA, Tris/Acetate/EDTA (TAE), Tris Borate EDTA (TBE), or lithium borate (LB). The buffers used at each electrode can be the same or different. Gels can comprise or be used in conjunction with dyes, including but not limited to, xylene cyanol, Cresol Red, Orange G, bromophenol blue, intercalating dyes (e.g., ethidium bromide, SYBR Green, EvaGreen), and protein stains (e.g., silver stain, Coomassie Brilliant Blue).

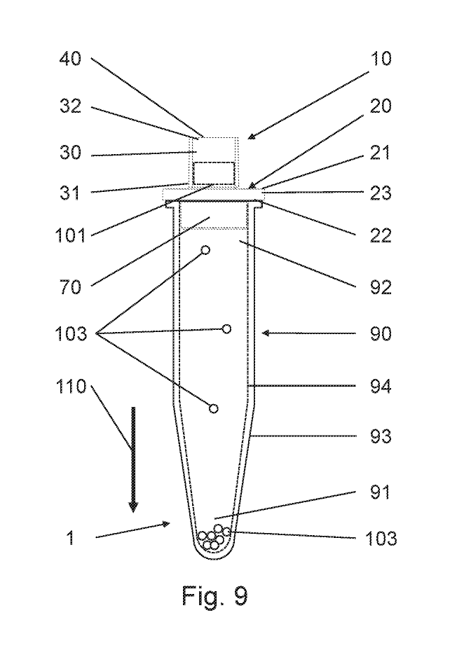

FIG. 9 shows an exemplary system and method of gel passing through the gel fragmentation system 1 when subjected to an acceleration 110. In an exemplary embodiment the gel excisor 10 is coupled at the open distal end 92 of the receiving container 90. When subjecting the coupled pair of gel excisor 10 and receiving container 90 to the acceleration 110, as is the case when the pair is placed in a centrifuge, the acceleration 110 may cause the target band 101 of gel disposed in the receptacle 30 of the gel excisor to be forced through a fragmentation membrane (best seen in FIGS. 2-4) causing the target band 101 of gel to be broken into smaller pieces 103 of gel. The acceleration 110 may be created manually or mechanically or both, by the user or by the user aided by additional equipment, such as a centrifuge. The magnitude and direction of the acceleration 110 may either partially or fully correspond to the centripetal acceleration caused by a centrifuge. The size and/or shape of the smaller pieces 103 of gel may be controlled by the fragmentation membrane or the fragmentation membrane holes or any combination thereof, to best facilitate the purposes of the fragmenting process or of a subsequent processing method, such as maximizing the surface area to volume ratio, minimizing the number of smaller pieces 103, or minimizing potential damage to the target component within the target band 101. The smaller pieces 103 may then be further cleaned, purified, filtered, or transferred, or any combination thereof. The subsequent processing methods include but are not limited to such techniques as amplification, cloning, dyeing, mass spectrometry, polymerase chain reaction, restriction fragment length polymorphism, sequencing, Southern blotting, tagging with a ligand, subjected to one or more assays, tagging for fluorescent imaging, or any combination thereof. Types of sequencing include but are not limited to Illumina next-generation sequencing techniques such as 16S metagenomics sequencing, bacterial genome sequencing, DNA sequencing, HiSeq sequencing, miRNA sequencing, MiSeq sequencing, NextSeq sequencing, PCR amplicon sequencing, and strand specific RNA sequencing. The acceleration 110 may urge the smaller pieces 103 of the gel toward the proximal end 91 of the receiving container 90 where they may aggregate.

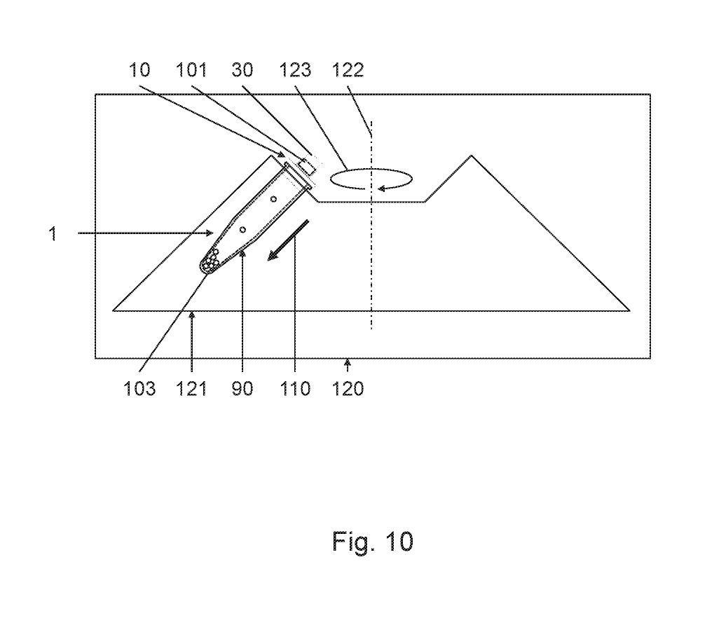

FIG. 10 shows an example of the gel fragmentation system 1 as placed into a centrifuge 120 for the processing described herein. The gel fragmentation system 1 may be placed in the centrifuge 120, spun about an axis 122 in a direction of rotation 123 by a rotator 121 and subjected to the acceleration 110 that may cause the target band 101 to pass through the fragmentation membrane of the gel excisor 10 and break into smaller pieces 103 that may be collected by the receiving container 90. The magnitude and direction of the rotation 123 may be of any value sufficient to break apart the target band without compromising the structure or function of the gel fragmentation system or centrifuge. Values for the rotational speed of the centrifuge 120 range from about 1,000 to about 10,000 rpm for low speed centrifugation, from about 10,000 to 30,000 rpm for high speed centrifugation, and from about 30,000 to 120,000 rpm for ultrcentrifugation. During any gel fragmentation procedure utilizing a centrifuge, the rotational speed may vary through any of these ranges or remain constant or some combination thereof. The direction of rotation 123 may be either clockwise or counter-clockwise and may change or remain constant during a gel fragmentation procedure. The rotator 121 may hold the gel fragmentation system at a fixed angle or a variable angle throughout a gel fragmentation procedure.

A number of centrifuges may be used including but not limited to: fixed-angle centrifuges that hold the gel fragmentation system 1 at a constant angle relative to the axis 122; swinging head centrifuges that have a hinge disposed near where the gel fragmentation system 1 is placed within the centrifuge to allow the gel fragmentation system 1 to swing outwards, inwards, up, and/or down as the centrifuge is spun; or continuous tubular centrifuges. Screen centrifuges, wherein acceleration allows liquids to pass through a screen while prevent solids from passing through, may also be used. Such screen centrifuges include but are not limited to conical plate centrifuges, decanter centrifuges, peeler centrifuges, pusher centrifuges, screen scroll centrifuges, and solid bowl centrifuges. Centrifugation may refer herein to differential centrifugation, isopycnic centrifugation, and/or rate-zonal centrifugation.

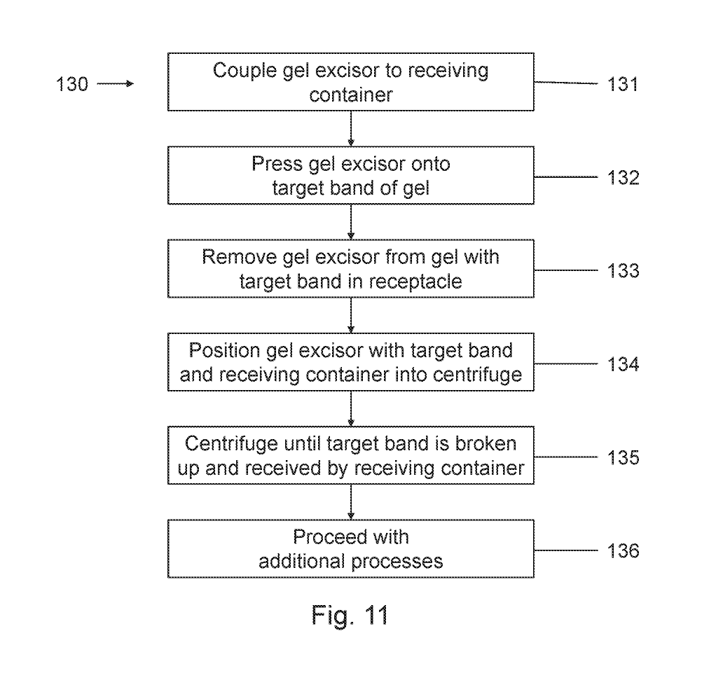

FIG. 11 shows a flowchart of a method 130 for gel fragmentation and processing with a centrifuge.

In operation 131, a gel excisor may be coupled to a receiving container. The gel excisor may be as disclosed herein. The receiving container as disclosed herein, such as an Eppendorf tube or any tube able to be centrifuged. Coupling the gel excisor to the receiving container may be done through a coupler disposed on either the gel excisor or the receiving container. The coupler may be shaped such that one or more of its surfaces may complement one or more surfaces of the gel excisor or the receiving container or both to aid in coupling. Coupling may be further aided by a locking mechanism that may optimize an interference fit, provide screw-like threads for engagement, or provide a small amount of adhesive, or any combination thereof.

In operation 132, the coupled pair of the gel excisor and receiving container may be pressed onto a target band of a gel. Pressing the gel excisor onto the gel may separate the target band from the rest. Moreover, pressing the gel excisor onto the gel may urge the target band into a receptacle where it may be retained for use in later operations. The target band may comprise a target component that may be a single band of DNA, RNA, protein, or molecular fragments, or any combination thereof.

In operation 133, the coupled pair of the gel excisor and receiving container may be removed from the gel.

Operations 132 and 133 may be repeated any number of times to obtain the desired amount of target components in target bands.

In operation 134, the coupled pair of the gel excisor and receiving container with the target band disposed within the system may be positioned into a centrifuge. The centrifuge may be of any type described herein. Examples of centrifuges include, without limitation, fixed-angle centrifuges; swinging head centrifuges, vertical tube rotor centrifuges, continuous tubular centrifuges, screen centrifuges, conical plate centrifuges, decanter centrifuges, peeler centrifuges, pusher centrifuges, screen scroll centrifuges, solid bowl centrifuges, differential centrifuges, isopycnic centrifuges, zonal rotor centrifuges, rate-zonal centrifuges, elutriator rotor centrifuges, general-purpose centrifuges, microcentrifuges, fixed-speed microcentrifuges, variable speed-microcentrifuges, refrigerated microcentrifuges, refrigerated centrifuges, pre-clinical centrifuges, Babcock centrifuges, laboratory centrifuges, hematocrit centrifuges, gas centrifuges, low-speed centrifuges, medium-speed centrifuges, high-speed centrifuges, ultracentrifuges, preparative ultracentrifuges, and analytical ultracentrifuges.

In operation 135, the coupled pair of the gel excisor and receiving container with the target band disposed within the system may be centrifuged until the target band is broken into smaller pieces. The target band may be broken apart by a fragmentation membrane disposed in the gel excisor. The smaller pieces may be collected by the receiving container.

In operation 136, a user, device, method, or system, or any combination thereof may proceed with additional processes. The additional processes include but are not limited to Illumina next-generation sequencing techniques such as 16S metagenomics sequencing, bacterial genome sequencing, DNA sequencing, HiSeq sequencing, miRNA sequencing, MiSeq sequencing, NextSeq sequencing, PCR amplicon sequencing, and strand specific RNA sequencing. One may also elect to not perform any additional process.

Although the above operations show the method 130 for gel excising, fragmentation, and processing in accordance with many embodiments, a person of ordinary skill in the art will recognize many variations based on the teachings described herein. The operations may be completed in a different order. Operations may be added or deleted. Some of these operations may comprise sub-operations. Many of the operations or sub-operations may be repeated as often as beneficial or desired for gel fragmentation and processing.

While preferred embodiments of the present disclosure have been shown and described herein, it will be obvious to those skilled in the art that such embodiments are provided by way of example only. Numerous variations, changes, and substitutions will now occur to those skilled in the art without departing from the scope of the present disclosure. It should be understood that various alternatives to the embodiments of the present disclosure described herein may be employed in practicing the present disclosure. It is intended that the following claims define the scope of the invention and that methods and structures within the scope of these claims and their equivalents be covered thereby.

What is claimed is:

1. A gel excision and fragmentation device, the device comprising:
a receptacle shaped to receive a band from a gel, the receptacle having a cutting edge shaped to cut the band from the gel when pressed thereon, thereby urging the cut band into the sample receptacle;
a fragmentation membrane having a first end operatively coupled to an end of the receptacle opposite the cutting edge and a second end; and
a coupler operatively coupled to the second end of the fragmentation membrane.

2. The gel excision and fragmentation device of claim 1, wherein the receptacle has a length between a proximal end of the receptacle and a distal end of the receptacle sufficient to hold at least a portion of an extracted gel band within the receptacle.

3. The gel excision and fragmentation device of claim 1, wherein the receptacle is shaped to hold a single band of target components, said band comprising a part of a plurality of bands generated during electrophoresis.

4. The gel excision and fragmentation device of claim 3, wherein the target components comprise deoxyribonucleic acid (DNA), ribonucleic acid (RNA), protein, or molecular fragments, or any combination thereof.

5. The gel excision and fragmentation device of claim 1, wherein the cutting edge of the receptacle comprises a free and rake angle both about 0° so that the cutting edge is dull to touch.

6. The gel excision and fragmentation device of claim 1, wherein the fragmentation membrane is configured to break down the received band of gel into smaller pieces.

7. The gel excision and fragmentation device of claim 6, wherein the fragmentation membrane comprises one or more holes to aid in breaking down the received band of gel by acting as a sieve through which the gel passes.

8. The gel excision and fragmentation device of claim 1, wherein the coupler has an inner surface and an outer surface, with the inner surface or the outer surface, or any combination thereof, providing a region configured to couple to a receiving container.

9. The gel excision and fragmentation device of claim 1, wherein the receptacle, the fragmentation membrane, and the coupler comprise a single, integral unit.

10. The gel excision and fragmentation device of claim 9, wherein the single, integral unit is made of a biologically inert, non-catalyzing, or non-reactive material.

11. A system for processing a band of a gel, the system comprising:
(i) a gel excision and fragmentation device comprising:
(a) a receptacle shaped to receive a band from a gel, the receptacle having a cutting edge shaped to cut the band from the gel when pressed thereon, thereby urging the cut band into the receptacle;
(b) a fragmentation membrane having a first end operatively coupled to an end of the receptacle opposite the cutting edge and a second end; and
(c) a coupler operatively coupled to the second end of the fragmentation membrane; and
(ii) a receiving container.

12. The system of claim 11, wherein the receiving container comprises a centrifuge tube with an open boundary at a distal end thereof and a closed boundary at a proximal end thereof.

13. The system of claim 11, wherein the receiving container comprises an Eppendorf tube.

14. The system of claim 11, wherein the coupler of the gel excision and fragmentation device is configured to be coupled to the receiving container.

15. The system of claim 14, wherein the coupling comprises an interference fit between the coupler of the gel excision and fragmentation device and the receiving container.

16. The system of claim 14, wherein the coupling is aided by a locking mechanism disposed on the coupler of the gel excision and fragmentation device.

17. The system of claim 11, wherein the system is configured to be manipulated by a user to cut a target band from a gel.

18. The system for processing a band extracted from a gel of claim 11, wherein the system is configured to be disposed within a centrifuge.

19. A method for processing a band of a gel, the method comprising:
pressing a cutting edge of a receptacle of a gel excision and fragmentation device against a gel to cut a gel band from the gel, thereby urging the cut gel band into the receptacle and capturing the cut gel band;
coupling a coupler of the gel excision fragmentation device with an opening of a receiving container;
centrifuging the coupled gel excision and fragmentation device and receiving container containing the captured gel band.

20. The method for processing a band from an electrophoresis gel of claim 19, wherein centrifuging the coupled gel excision and fragmentation device comprises forcing the captured gel band through a fragmentation membrane of the gel excision and fragmentation device, thereby breaking the captured gel band into gel fragments, and collecting the gel fragments in the receiving container.
